(19) United States
(12) Patent Application Publication
(10) Pub. No.: US 2026/0245750 A1
(43) Pub. Date: Aug. 20, 2026

(54) Swell Resistant Fuel Pellets and Methods of Manufacture Thereof

(71) Applicant: JFoster & Associates, LLC, Idaho Falls, ID (US)

(72) Inventors: Patrick John MOO, Shelley, ID (US); John Darrell BESS, Idaho Falls, ID (US)

(21) Appl. No.: 19/054,508

(22) Filed: Feb. 14, 2025

(51) Int. Cl. G21C 3/04; G21C 3/60; G21C 21/10

(52) U.S. Cl. CPC G21C 3/047; G21C 3/044; G21C 3/048; G21C 3/60; G21C 21/10

(57) ABSTRACT

A nuclear fuel pellet may include a metallic fuel material including a nuclear fuel, the metallic fuel material having a metallic matrix defining a porosity of at least 10% prior to a fissile reaction. A nuclear fuel pellet may include a cladding material positioned radially outward of the metallic fuel material relative to a longitudinal axis of the metallic fuel material.

### GOVERNMENT SUPPORT STATEMENT

This invention was made with government support under DE-SC0023732 and DE-SC0023935 awarded by the United States Department of Energy. The government has certain rights in the invention.

### BACKGROUND

### Background and Relevant Art

Most nuclear fuel materials include one or more of the elements of uranium and plutonium. There are, however, different types or forms of nuclear fuel materials that include such elements. For example, nuclear fuel pellets (NFPs) may be used to accommodate a variety of reactor sizes and types.

The nuclear reaction including the NFPs involves the disintegration of the nuclear fuel material into two or more fission products of lower mass number. The reaction process produces a net increase in the available free neutrons, which form the basis for a self-sustaining nuclear reaction. To control the rate of the nuclear reaction, neutron-capturing elements may be added to the nuclear fuel material to compensate for initial higher reactivity of the nuclear fuel material. Neutron-capturing elements can include a neutron capturing material (e.g., burnable absorber or burnable neutron capturing material) that has a high probability of absorbing neutrons while producing no new or additional neutrons or changing into new neutron capturing materials as a result of neutron absorption.

During a nuclear reaction, heat is generated within the NFP and, more particularly, a thermal gradient is generated within the NFP such that the greatest heat is generated in a central region (e.g., lateral and/or longitudinal center) of the NFP. However, neutron capturing materials can have a lower melting point relative to nuclear fuel materials within the NFP, which can result in the NFP softening and changing geometries as the heat increases. The combination of the NFP softening and generation of the thermal gradient contributes to deformation of the NFP. Deformation of the NFP is described as taking on an hourglass shape. The combination of hourglass shape and pellet cracking create shearing pinch points (triple points) onto the inner diameter of the fuel cladding. These pellet-cladding-mechanical-interactions (PCMI) can lead to rupture of the cladding material which serves as a barrier between the NFPs and the reactor coolant.

### BRIEF SUMMARY

In some aspects, the techniques described herein relate to a nuclear fuel pellet including: a metallic fuel material including a nuclear fuel, the metallic fuel material having a metallic matrix defining a porosity of at least 10% prior to a fissile reaction; and a cladding material positioned radially outward of the metallic fuel material relative to a longitudinal axis of the metallic fuel material.

In some aspects, the techniques described herein relate to a method of manufacturing a fuel pellet: forming a metallic fuel material including a nuclear fuel into a body with a metallic matrix having a porosity of no less than 10% prior to a fissile reaction; and cladding the body with a cladding material that directly contacts a radially outward surface of the body without an intermediate layer therebetween.

In some aspects, the techniques described herein relate to a nuclear fuel pellet including: a cylindrical body, the body including a metallic fuel material including a nuclear fuel, wherein the metallic fuel material has a metallic matrix with an open porous system defining a porosity of at least 10% prior to a fissile reaction; and a cladding material contacting a radially outward surface and an axial surface of the metallic fuel material relative to a longitudinal axis of the metallic fuel material.

This Summary is provided to introduce a selection of concepts in a simplified form that are further described below in the Detailed Description. This Summary is not intended to identify key features or essential features of the claimed subject matter.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1-1 is a transverse cross-sectional view of a conventional nuclear fuel pellet (NFP).

FIG. 1-2 is a transverse cross-sectional view of another conventional NFP.

FIG. 2 is a transverse cross-sectional view of a substantially cylindrical NFP including a porous body, according to at least some embodiments of the present disclosure.

FIG. 3 is a transverse cross-sectional view of an NFP including a plurality of body materials in the body, according to at least some embodiments of the present disclosure.

FIG. 4 is a flowchart illustrating a method for manufacturing an NFP, according to at least some embodiments of the present disclosure.

FIG. 5 is a longitudinal cross-sectional view of an NFP, according to at least some embodiments of the present disclosure.

FIG. 6 is a longitudinal cross-sectional view of another embodiment of an NFP, according to at least some embodiments of the present disclosure.

FIG. 7 is a schematic illustration of a metallic fuel material having a closed pore system, according to at least some embodiments of the present disclosure.

FIG. 8 is a schematic illustration of an open pore system exhibiting close packing of spheres, according to at least some embodiments of the present disclosure.

### DETAILED DESCRIPTION

The present disclosure generally relates to nuclear fuel pellets (NFPs) and to the systems and methods for manufacturing NFPs. More particularly, the present disclosure relates to porous NFPs and to the systems and methods for manufacturing porous NFPs. In some embodiments, an NFP according to the present disclosure includes a first region containing a porous first material including a nuclear fuel and a second region positioned around at least a portion of the first region, where the second region contains a second material different from the first material. In some embodiments, the second material is a cladding material. In some embodiments, the second material includes the nuclear fuel in a different proportion. In some embodiments, the second material includes a different nuclear fuel. In some embodiments, the second material lacks a nuclear fuel. In some embodiments, the NFP includes a cladding material around and/or encapsulating the first material and the second material.

In some embodiments, the first material is or includes a metallic nuclear fuel. In some examples, metallic nuclear fuels have superior heat transfer properties over ceramic nuclear fuels. This improves performance and safety margins in nuclear reactors. Metallic fuels have potential use in a variety of reactor types including metal-cooled, water-cooled, gas-cooled, and salt-cooled systems.

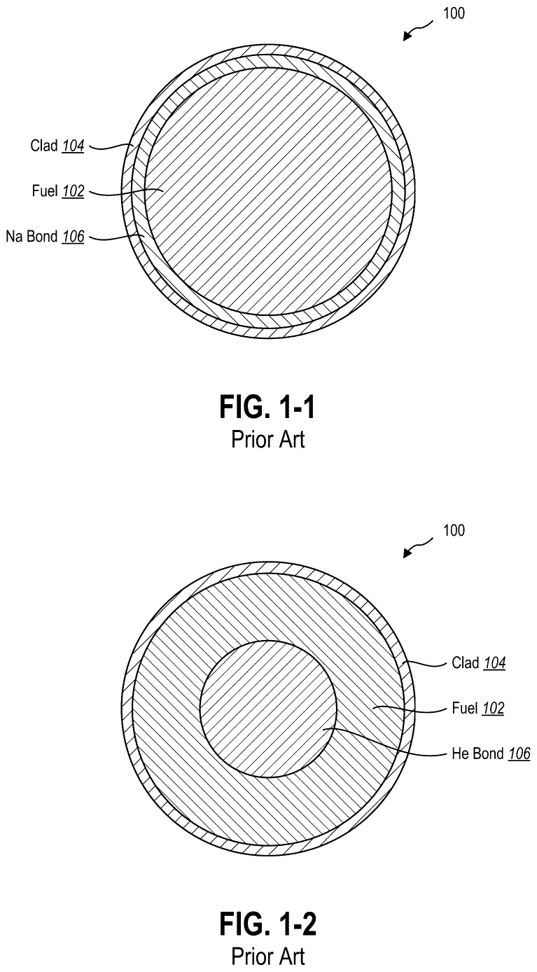

Referring now to FIG. 1-1, conventional metallic NFPs 100 including metallic nuclear fuels are susceptible to significant swelling during the early stages of burnup of the nuclear fuel cycle. This is a result of accumulation of gaseous fission products within the dense metallic fuel body 102. When a fresh metallic NFP is loaded into a reactor core, it is in a fully dense state. Full density is a result of the manufacturing processes that have been historically used to produce such fuels, which include billet extrusion and injection casting. From its initial fully dense state when loaded into the reactor core, swelling proceeds until the body 102 containing the nuclear fuel has reached an approximately 75% dense state and is in contact with the cladding material 104. The body 102 of the fresh fuel has an initial diameter that is significantly less than the inner diameter of the cladding material 104 to accommodate space for the swelling effect. This results in poor heat transfer from the fuel of the body 102 to the cladding material 104 and ultimately to a coolant (typically a liquid coolant) external to the NFP 100. To compensate, conventional NFPs 100 may include a sodium bond layer 106 radially inside the cladding material 104 between the cladding material 104 and the body 102 to facilitate heat transfer between body 102 and the cladding material 104 during the early stages of burnup. The use of the sodium bond layer 106 in conventional NFPs 100 adds cost to the nuclear fuel cycle since the sodium bond layer 106 is treated as a mixed waste after the fuel is unloaded from the reactor core.

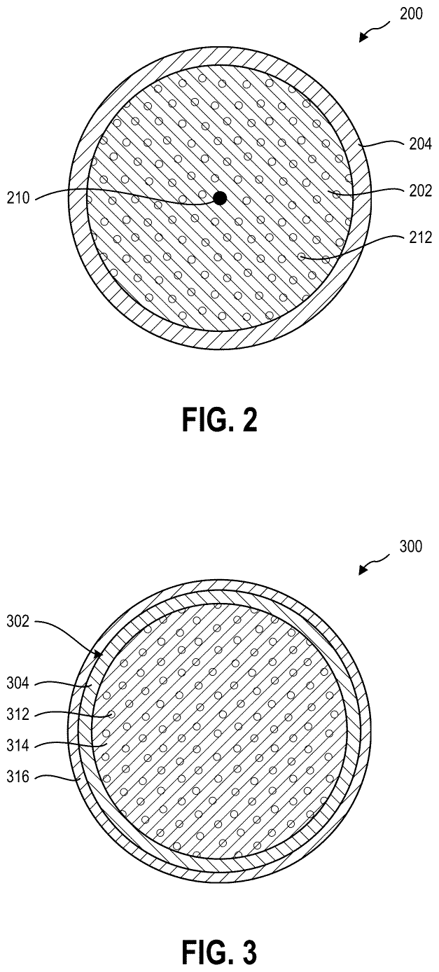

FIG. 1-2 is a transverse cross-sectional view of another conventional NFP 100 in which the body 102 containing the nuclear fuel is arranged around a helium bond 108 and configured to swell radially inward toward a longitudinal axis 110 of the NFP 100. The body 102 contains a void, channel, or opening radially within the substantially annular body 102. The cladding material 104 is positioned around the body 102 to receive and transfer heat from the body 102 while the helium bond 108 provides space for the body 102 to swell inward and avoid damage to the cladding material 104.

In some embodiments, an NFP according to the present disclosure includes a body having a metallic nuclear fuel therein that is configured to resist swelling. In some embodiments, an NFP according to the present disclosure is dimensionally stable during burnup. For example, a dimensionally stable NFP does not swell radially outward, inward, longitudinally, or in any other dimension during fissile reactions in a reactor. In some examples, a dimensionally stable NFP may have a lower risk of failure of the cladding material. In some examples, a dimensionally stable body of an NFP may be closer to a final dimension of the NFP, reducing steps and cost to manufacturing. In some examples, a dimensionally stable NFP may limit and/or reduce the need for a sodium bond layer or helium body layer that can add steps and cost to disposal.

NFPs, according to at least some embodiments of the present disclosure, have a porous body. FIG. 2 is a transverse cross-sectional view of an embodiment of a substantially cylindrical NFP 200 including a porous body 202. In some embodiments, the body 202 includes a metallic nuclear fuel in a metallic matrix containing a plurality of pores 212. In some embodiments, the pores 212 allow the fissile gases formed during burnup to enter the pores 212 and reduce swelling. In some embodiments, the pores 212 allow the fissile gases formed during burnup to flow through the pores 212 and balance pressures across and/or within the body 202 and/or NFP 200 to reduce swelling. In some embodiments, the pores 212 allow the fissile gases formed during burnup to flow through the pores 212 and exit the body 202 of the NFP 200.

As described herein, in some embodiments, a dimensionally stable body 202 limits and/or eliminates the need for a layer between the cladding material 204 and the body 202. In some embodiments, the body 202 directly contacts the cladding material 204.

In some embodiments, the metallic fuel material of the body 202 is substantially homogeneous. In some embodiments, the metallic matrix of the body 202 is substantially homogeneous and a second phase (such as a binder, oxide layer, or other phase, as will discussed below) is present in within the metallic matrix of the body 202. In some embodiments, a second phase lines at least a portion of the plurality of pores 212 of the metallic matrix of the body 202.

In some embodiments, the metallic fuel material of the body 202 is porous prior to any fissile reaction. In other words, the metallic fuel material of the body 202 is porous at the time of manufacturing prior to loading into a reactor. In some embodiments, the metallic fuel material of the body 202 has a porosity of no less than 10%. In some embodiments, the metallic fuel material of the body 202 has a porosity of no less than 15%. In some embodiments, the metallic fuel material of the body 202 has a porosity of no less than 20%. In some embodiments, the metallic fuel material of the body 202 has a porosity of no less than 25%.

Referring now to FIG. 3, in some embodiments, an NFP 300 includes a plurality of body materials in the body 302. In some embodiments, a second body material 314 is present between the metallic fuel material 316 of the body 302 and the cladding material 304. In some embodiments, the second body material 314 is or includes a neutron capturing material, breeding material, inert material, etc. In some embodiments, the second body material 314 includes the nuclear fuel material in a different proportion than the metallic fuel material 316.

Similar to that described in relation to FIG. 2, in some embodiments, the metallic fuel material 316 of the body 302 has a porosity of no less than 10%. In some embodiments, the metallic fuel material 316 of the body 302 has a porosity of no less than 15%. In some embodiments, the metallic fuel material 316 of the body 302 has a porosity of no less than 20%. In some embodiments, the metallic fuel material 316 of the body 302 has a porosity of no less than 25%.

In some embodiments, the second body material 314 is fully dense. For example, the second body material 314 may not include nuclear fuel material, and therefore, may not contribute to swelling of the NFP 300. In some embodiments, the second body material 314 includes a plurality of pores to allow fissile gases to move therein, whether or not the second body material 314 includes nuclear fuel material. In some embodiments, the second body material 314 has a porosity of no less than 10%. In some embodiments, the second body material 314 has a porosity of no less than 15%. In some embodiments, the second body material 314 has a porosity of no less than 20%. In some embodiments, the second body material 314 has a porosity of no less than 25%. In some embodiments, the second body material 314 has the same porosity as the metallic fuel material 316.

In some embodiments, the NFP has a configuration for extended burnup and rim effect suppression. A metallic fuel material 316 in a primarily fissile first region may include 10% enriched LEU or similar and second body material 314 in a second region may include ²³⁸U or ²³²Th species (“Fertile”). An ‘inert’ material or component of a material may be ZrO₂ or other non-breeding material. Other additions may include moderators, such as BeO, or burnable neutron capturing materials, such as Gd₂O₃. It should be understood that any specific compositions described herein are exemplary and not limiting.

Generally, the NFP 300 may include (e.g., be comprised of) any appropriate nuclear fuel material. In some embodiments, the nuclear fuel material may comprise one or more of uranium, zirconium, tungsten, rhenium, molybdenum, tantalum, iridium, uranium dioxide (UO₂), uranium oxide (e.g., U₃O₈), uranium nitride (e.g., UN, U₂N₃, etc.), uranium silicide (e.g., U₃Si₂), uranium borides (e.g., UB₂, UB₄), a transuranic material (e.g., plutonium, plutonium oxide), minor actinides (e.g. neptunium, americium, curium), thorium, oxides thereof, another nuclear fuel material, or combinations thereof. The NFP 300 may also include (e.g., be comprised of) any appropriate additive, or dopant, material. In some embodiments, the additive material may be a neutron capturing material, such as a burnable neutron capturing material. In some embodiments, the neutron capturing material may comprise one or more of boron, gadolinium, gadolinium oxide (Gd₂O₃), boron carbide (B₄C), another material exhibiting a high thermal neutron absorption cross-section, and combinations thereof. Other neutron capturing materials may include, molybdenum, neodymium, cadmium, erbium, hafnium, another neutron absorber, or combinations thereof.

In some embodiments, the neutron capturing material may be disposed in a region of the NFP 300 in which it will have the greatest impact on the nuclear reaction within a nuclear reactor (e.g., to enhance neutronic efficiency of the nuclear fuel material and the neutron capturing material therein) and may be excluded from other regions of the NFP 300. In other embodiments, the neutron capturing material may also be excluded from or reduced in a gradient toward the axial surfaces of the NFP 300.

For example, the NFP 300 may be heterogeneous in composition across a height thereof (e.g., axially, in the longitudinal direction) and/or across a width thereof (e.g., radially from the longitudinal axis), such that amounts (e.g., concentrations) of one or more elements thereof are non-uniform within the NFP 300 and/or within one or more regions of the NFP 300. The heterogeneity of the NFP 300 and/or regions of the NFP 300 may be substantially undetectable by visual inspection (e.g., no clear delineation of first region and second regions), but the heterogeneity of the NFP 300 and/or regions of the NFP 300 may be detectable by conventional spectroscopy or spectrometry techniques. A boundary between regions of different compositions within the fuel pellets may generally have a roughness at least partially defined by the microstructure of the NFP 300. Fine-grained and uniformed materials may exhibit a smoother or more uniform boundary, and coarse-grained materials may exhibit a rougher boundary. Some irregularity of the boundary may also be attributable to different particle sizes in various regions of the NFP 300.

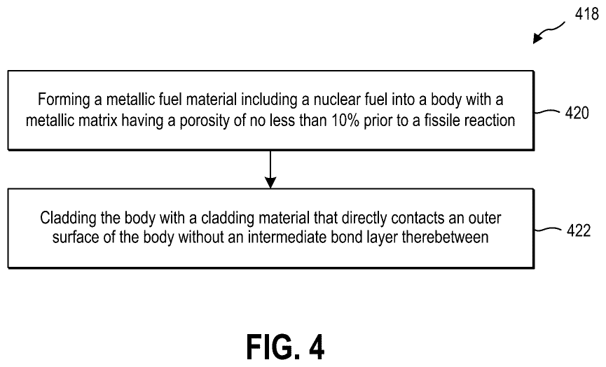

FIG. 4 is a flowchart illustrating an embodiment of a method 418 for manufacturing an NFP. In some embodiments, the method includes forming a metallic fuel material including a nuclear fuel into a body with a metallic matrix having a porosity of no less than 10% prior to a fissile reaction at 420. In some embodiments, forming the metallic fuel material into a body includes sintering the metallic fuel material. In some embodiments, forming the metallic fuel material into a body includes extruding the metallic fuel material. In some embodiments, forming the metallic fuel material into a body includes coextruding a plurality of body materials including the metallic fuel material. In some embodiments, forming the metallic fuel material into a body includes overmolding the metallic fuel material with a second body material. In some embodiments, forming the metallic fuel material into a body includes additively manufacturing the metallic fuel material into a near-final shape. In some embodiments, forming the metallic fuel material into a body includes a combination of the foregoing. For example, a metallic fuel material may be extruded to form a first region of the body, and a second body material may be subsequently overmolded around the metallic fuel material in a second region to form the body.

The size, quantity, and morphology of the porosity within a metallic fuel material can be adjusted when forming the metallic fuel material into a body. the controlled by one or more of four parameters: Particle size distribution (PSD) of the raw starting powders, sintering temperature, green density (ie, pre-sintered density or solid loading in a binder matrix), and/or use of pore forming agents (which may include the binders themselves). This contrasts with billet extrusion and injection casting techniques, where such parameters are non-controllable or non-existent.

In some embodiments, the size, quantity, and morphology of the porosity within a metallic fuel material can be adjusted after forming the metallic fuel into a body. For example, debinding, de passivation, or other post processing techniques may further alter the porosity of the metallic fuel material. In some embodiments, the metallic fuel material may be formed with a metallic matrix having a porosity no less than 10%, but the actual porosity (e.g., open space in the matrix) may be less due to binders or other agents in the pores. Debinding of the metallic fuel material may increase the actual porosity by removing at least a portion of the binder in the pores.

In at least one example, forming the metallic fuel material into a body includes loading a powder into a binder system. In some embodiments, the binder system includes one or more polymers (such as polyethylene, polystyrene, polypropylene, etc.). In some embodiments, the binder system includes one or more plasticizers (such as paraffin wax, palm oil, etc.). In some embodiments, the binder system includes both a polymer and a plasticizer. In some embodiments, the mixture is heated and compounded to a substantially homogeneous state to create a formable feedstock material before forming the metallic fuel material into a body.

Metallic nuclear fuels are prone to pyrophoric reaction when in powder form. In some embodiments, the metallic nuclear fuel is passivated during the powder forming process. In some examples, passivation introduces a small quantity of oxygen into the powder forming system (such as a metal powder atomizer). During this step a nanometric oxide layer is formed on each particle surface of the powder and prevents the material from rapid oxidation (i.e., ignition) when introduced to ambient air. Pyrophoricity is further reduced when the raw powder is loaded into the binder system, which encapsulates powder from ambient air. The encapsulation within the binder also prevents the spread or dispersal of powder in a fuel fabrication facility.

In some embodiments, the method 418 further includes debinding the metallic fuel material of the body. For example, once a part is formed, the binder and particle oxide layer are removed. In some embodiments, debinding includes the use of solvent, catalytic, and/or thermal driven processes. In some embodiments, the part is then subjected to elevated temperature to achieve the desired final density (i.e. sintering step). For example, the elevated temperature may densify the material, promote recrystallization, promote interstitial growth, etc. In some embodiments, the elevated temperature may sinter at least a portion of the metallic fuel material. During the sintering step, the oxide layer produced during the passivation step may be removed under a controlled reducing atmosphere. In some embodiments, the de-passivation occurs under a reducing atmosphere consisting of 0.01-100% hydrogen content and/or the use of partial pressure (i.e., partial vacuum) ranging from 0.0001-760 torr.

The method 418 further includes cladding the body with a cladding material that directly contacts the surface of the body without an intermediate bond layer therebetween at 422. As described herein, a bond layer as used in a convention NFP is not necessary for a dimensionally stable body including porous metallic fuel material such as described herein. In some embodiments, the cladding is in direct contact with the metallic fuel material of the body. In some embodiments, the cladding is in direct contact with a second body material of the body.

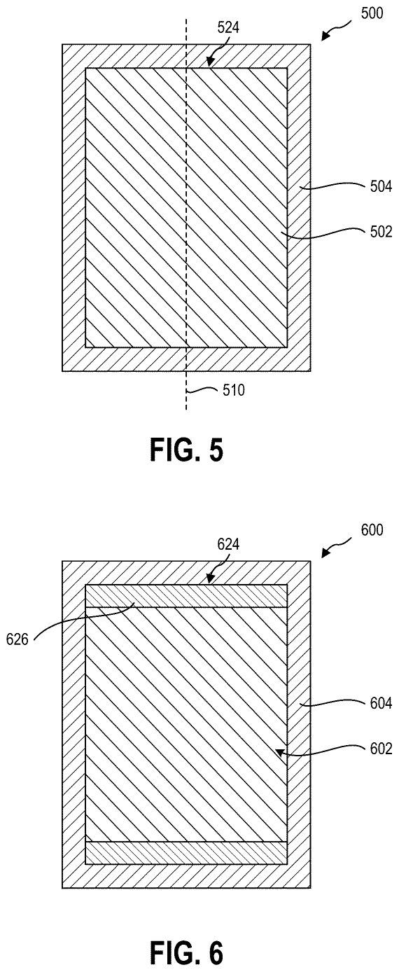

FIG. 5 is a longitudinal cross-sectional view of an embodiment of an NFP 500 according to the present disclosure. In some embodiments, the cladding material 504 is located around the body 502 including the porous metallic fuel material in a radial direction relative to a longitudinal axis 510. In some embodiments, the cladding material 504 is located at an axial surface(s) 524 of the body 502 in the longitudinal direction. In some embodiments, the cladding material 504 is substantially continuous from the radially outward surface of the body 502 to and/or across the axial surfaces 524 of the body 502.

FIG. 6 is a longitudinal cross-sectional view of another embodiment of an NFP 600 according to the present disclosure. In some embodiments, the cladding material 604 is located around the body 602 including the porous metallic fuel material in a radial direction relative to a longitudinal axis 610. In some embodiments, the cladding material 604 is located at an axial surface(s) 624 of the body 602 in the longitudinal direction with an axial layer 626 between the body 602 and the cladding material 604. In some embodiments, the cladding material 604 is substantially continuous from the radially outward surface of the body 602 to and/or across the axial layer(s) 626. In some embodiments, the axial layer 626 is or includes a bond layer, such as a helium bond layer and/or a sodium bond layer. In some embodiments, the axial layer(s) 626 is or includes a nuclear fuel material, neutron capturing material, breeding material, inert material, etc. to control the burnup of the nuclear fuel material proximate to the axial surface 624 of the body 602.

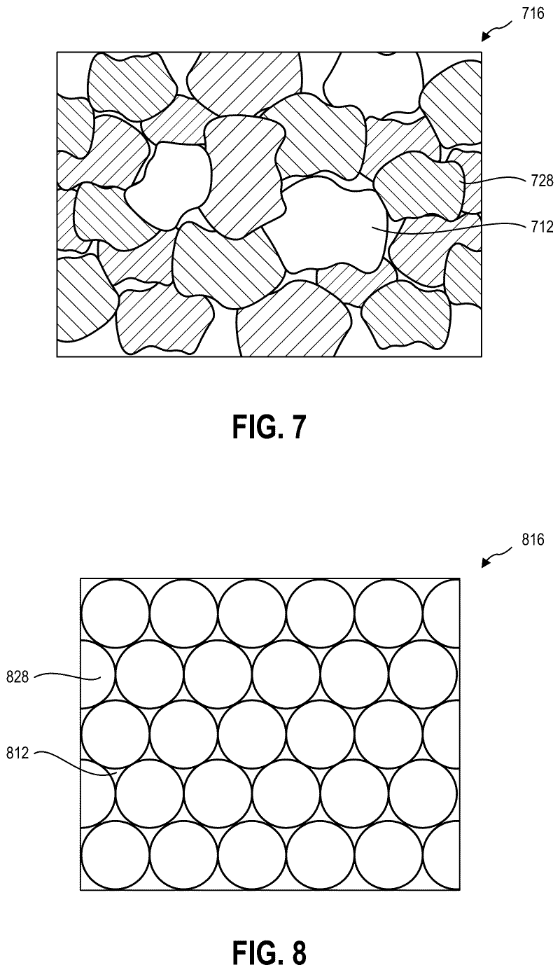

While embodiments of NFPs and metallic fuel materials having a porous structure have been described herein, in some embodiments, the metallic fuel material has a closed pore system, and, in some embodiments, the metallic fuel material has an open pore system. FIG. 7 is a schematic illustration of a metallic fuel material 716 having a closed pore system. In some embodiments, the closed pore system includes a plurality of pores 712 in the structure of the metallic fuel material 716 between particles or grains 728. In some embodiments, the grains 728 are microstructural grains exhibiting a single, continuous crystal structure in the grain. In some embodiments, the grains 728 are individual particles, such as in the powder precursor mixed prior to the formation of the body of the NFP during manufacturing. For example, the particles of the metallic fuel material may sinter together to form the bonded grains 728 of the closed pore system. In some embodiments, the pores 712 of a closed pore system do not connect with one another to provide fluid flow therebetween. In some embodiments, a closed pore system has at least 50% of the pores 712 isolated without fluid flow therebetween. In some embodiments, the closed pore system has at least 75% of the pores 712 isolated without fluid flow therebetween.

FIG. 8 is a schematic illustration of an open pore system exhibiting close packing of spheres. In some embodiments, the grains 828 of the metallic fuel material 816 may be approximated as substantially spherical. In such examples, a close packing of the grains 828 allows an open path of fluid flow between the particles, flowing fluid through the pores 812 of the metallic matrix. In a particular example, hexagonal close packing of substantially spherical grains 828 allows approximately 26% porosity in the resulting structure between the grains 828.

The fluid flow into and/or through the pores of the metallic fuel material may allow a porous NFP to resist swelling during fissile reactions in a reactor. By limiting and/or preventing swelling, some embodiments of NFPs according to the present disclosure can have a larger volume of the fuel material in the body, be manufactured and/or disposed of more easily, and limit and/or prevent failures of the NFP during reaction.

### INDUSTRIAL APPLICABILITY

The present disclosure generally relates to nuclear fuel pellets (NFPs) and to the systems and methods for manufacturing NFPs. More particularly, the present disclosure relates to porous NFPs and to the systems and methods for manufacturing porous NFPs. In some embodiments, an NFP according to the present disclosure includes a first region containing a porous first material including a nuclear fuel and a second region positioned around at least a portion of the first region, where the second region contains a second material different from the first material. In some embodiments, the second material is a cladding material. In some embodiments, the second material includes the nuclear fuel in a different proportion. In some embodiments, the second material includes a different nuclear fuel. In some embodiments, the second material lacks a nuclear fuel. In some embodiments, the NFP includes a cladding material around and/or encapsulating the first material and the second material.

In some embodiments, the first material is or includes a metallic nuclear fuel. In some examples, metallic nuclear fuels have superior heat transfer properties over ceramic nuclear fuels. This improves performance and safety margins in nuclear reactors. Metallic fuels have potential use in a variety of reactor types including metal-cooled, water-cooled, gas-cooled, and salt-cooled systems.

In some embodiments, an NFP according to the present disclosure includes a body having a metallic nuclear fuel therein that is configured to resist swelling. In some embodiments, an NFP according to the present disclosure is dimensionally stable during burnup. For example, a dimensionally stable NFP does not swell radially outward, inward, longitudinally, or in any other dimension during fissile reactions in a reactor. In some examples, a dimensionally stable NFP may have a lower risk of failure of the cladding material. In some examples, a dimensionally stable body of an NFP may be closer to a final dimension of the NFP, reducing steps and cost to manufacturing. In some examples, a dimensionally stable NFP may limit and/or reduce the need for a sodium bond layer or helium body layer that can add steps and cost to disposal.

NFPs, according to at least some embodiments of the present disclosure, have a porous body. In some embodiments, the body includes a metallic nuclear fuel in a metallic matrix containing a plurality of pores. In some embodiments, the pores allow the fissile gases formed during burnup to enter the pores and reduce swelling. In some embodiments, the pores allow the fissile gases formed during burnup to flow through the pores and balance pressures across and/or within the body and/or NFP to reduce swelling. In some embodiments, the pores allow the fissile gases formed during burnup to flow through the pores and exit the body of the NFP.

As described herein, in some embodiments, a dimensionally stable body limits and/or eliminates the need for a layer between the cladding material and the body. In some embodiments, the body directly contacts the cladding material.

In some embodiments, the metallic fuel material of the body is substantially homogeneous. In some embodiments, the metallic matrix of the body is substantially homogeneous and a second phase (such as a binder, oxide layer, or other phase, as will discussed below) is present in within the metallic matrix of the body. In some embodiments, a second phase lines at least a portion of the plurality of pores of the metallic matrix of the body.

In some embodiments, the metallic fuel material of the body is porous prior to any fissile reaction. In other words, the metallic fuel material of the body is porous at the time of manufacturing prior to loading into a reactor. In some embodiments, the metallic fuel material of the body has a porosity of no less than 10%. In some embodiments, the metallic fuel material of the body has a porosity of no less than 15%. In some embodiments, the metallic fuel material of the body has a porosity of no less than 20%. In some embodiments, the metallic fuel material of the body has a porosity of no less than 25%.

In some embodiments, an NFP includes a plurality of body materials in the body. In some embodiments, a second body material is present between the metallic fuel material of the body and the cladding material. In some embodiments, the second body material is or includes a neutron capturing material, breeding material, inert material, etc. In some embodiments, the second body material includes the nuclear fuel material in a different proportion than the metallic fuel material.

In some embodiments, the metallic fuel material of the body has a porosity of no less than 10%. In some embodiments, the metallic fuel material of the body has a porosity of no less than 15%. In some embodiments, the metallic fuel material of the body has a porosity of no less than 20%. In some embodiments, the metallic fuel material of the body has a porosity of no less than 25%.

In some embodiments, the second body material is fully dense. For example, the second body material may not include nuclear fuel material, and therefore, may not contribute to swelling of the NFP. In some embodiments, the second body material includes a plurality of pores to allow fissile gases to move therein, whether or not the second body material includes nuclear fuel material. In some embodiments, the second body material has a porosity of no less than 10%. In some embodiments, the second body material has a porosity of no less than 15%. In some embodiments, the second body material has a porosity of no less than 20%. In some embodiments, the second body material has a porosity of no less than 25%. In some embodiments, the second body material has the same porosity as the metallic fuel material.

In some embodiments, the NFP has a configuration for extended burnup and rim effect suppression. A metallic fuel material in a primarily fissile first region may include 10% enriched LEU or similar and second body material in a second region may include ²³⁸U or ²³²Th species (“Fertile”). An ‘inert’ material or component of a material may be ZrO₂ or other non-breeding material. Other additions may include moderators, such as BeO, or burnable neutron capturing materials, such as Gd₂O₃. It should be understood that any specific compositions described herein are exemplary and not limiting.

Generally, the NFP may include (e.g., be comprised of) any appropriate nuclear fuel material. In some embodiments, the nuclear fuel material may comprise one or more of uranium, zirconium, tungsten, rhenium, molybdenum, tantalum, iridium, uranium dioxide (UO₂), uranium oxide (e.g., U₃O₈), uranium nitride (e.g., UN, U₂N₃, etc.), uranium silicide (e.g., U₃Si₂), uranium borides (e.g., UB₂, UB₄), a transuranic material (e.g., plutonium, plutonium oxide), minor actinides (e.g. neptunium, americium, curium), thorium, oxides thereof, another nuclear fuel material, or combinations thereof. The NFP 300 may also include (e.g., be comprised of) any appropriate additive, or dopant, material. In some embodiments, the additive material may be a neutron capturing material, such as a burnable neutron capturing material. In some embodiments, the neutron capturing material may comprise one or more of boron, gadolinium, gadolinium oxide (Gd₂O₃), boron carbide (B₄C), another material exhibiting a high thermal neutron absorption cross-section, and combinations thereof. Other neutron capturing materials may include, molybdenum, neodymium, cadmium, erbium, hafnium, another neutron absorber, or combinations thereof.

In some embodiments, the neutron capturing material may be disposed in a region of the NFP in which it will have the greatest impact on the nuclear reaction within a nuclear reactor (e.g., to enhance neutronic efficiency of the nuclear fuel material and the neutron capturing material therein) and may be excluded from other regions of the NFP. In other embodiments, the neutron capturing material may also be excluded from or reduced in a gradient toward the axial surfaces of the NFP.

For example, the NFP may be heterogeneous in composition across a height thereof (e.g., axially, in the longitudinal direction) and/or across a width thereof (e.g., radially from the longitudinal axis), such that amounts (e.g., concentrations) of one or more elements thereof are non-uniform within the NFP and/or within one or more regions of the NFP. The heterogeneity of the NFP and/or regions of the NFP may be substantially undetectable by visual inspection (e.g., no clear delineation of first region and second regions), but the heterogeneity of the NFP and/or regions of the NFP may be detectable by conventional spectroscopy or spectrometry techniques. A boundary between regions of different compositions within the fuel pellets may generally have a roughness at least partially defined by the microstructure of the NFP. Fine-grained and uniformed materials may exhibit a smoother or more uniform boundary, and coarse-grained materials may exhibit a rougher boundary. Some irregularity of the boundary may also be attributable to different particle sizes in various regions of the NFP.

In some embodiments, a method for manufacturing an NFP includes forming a metallic fuel material including a nuclear fuel into a body with a metallic matrix having a porosity of no less than 10% prior to a fissile reaction. In some embodiments, forming the metallic fuel material into a body includes sintering the metallic fuel material. In some embodiments, forming the metallic fuel material into a body includes extruding the metallic fuel material. In some embodiments, forming the metallic fuel material into a body includes coextruding a plurality of body materials including the metallic fuel material. In some embodiments, forming the metallic fuel material into a body includes overmolding the metallic fuel material with a second body material. In some embodiments, forming the metallic fuel material into a body includes additively manufacturing the metallic fuel material into a near-final shape. In some embodiments, forming the metallic fuel material into a body includes a combination of the foregoing. For example, a metallic fuel material may be extruded to form a first region of the body, and a second body material may be subsequently overmolded around the metallic fuel material in a second region to form the body.

The size, quantity, and morphology of the porosity within a metallic fuel material can be adjusted when forming the metallic fuel material into a body. the controlled by one or more of four parameters: Particle size distribution (PSD) of the raw starting powders, sintering temperature, green density (i.e., pre-sintered density or solid loading in a binder matrix), and/or use of pore forming agents (which may include the binders themselves). This contrasts with billet extrusion and injection casting techniques, where such parameters are non-controllable or non-existent.

In some embodiments, the size, quantity, and morphology of the porosity within a metallic fuel material can be adjusted after forming the metallic fuel into a body. For example, debinding, de passivation, or other post processing techniques may further alter the porosity of the metallic fuel material. In some embodiments, the metallic fuel material may be formed with a metallic matrix having a porosity no less than 10%, but the actual porosity (e.g., open space in the matrix) may be less due to binders or other agents in the pores. Debinding of the metallic fuel material may increase the actual porosity by removing at least a portion of the binder in the pores.

In at least one example, forming the metallic fuel material into a body includes loading a powder into a binder system. In some embodiments, the binder system includes one or more polymers (such as polyethylene, polystyrene, polypropylene, etc.). In some embodiments, the binder system includes one or more plasticizers (such as paraffin wax, palm oil, etc.). In some embodiments, the binder system includes both a polymer and a plasticizer. In some embodiments, the mixture is heated and compounded to a substantially homogeneous state to create a formable feedstock material before forming the metallic fuel material into a body.

Metallic nuclear fuels are prone to pyrophoric reaction when in powder form. In some embodiments, the metallic nuclear fuel is passivated during the powder forming process. In some examples, passivation introduces a small quantity of oxygen into the powder forming system (such as a metal powder atomizer). During this step a nanometric oxide layer is formed on each particle surface of the powder and prevents the material from rapid oxidation (i.e., ignition) when introduced to ambient air. Pyrophoricity is further reduced when the raw powder is loaded into the binder system, which encapsulates powder from ambient air. The encapsulation within the binder also prevents the spread or dispersal of powder in a fuel fabrication facility.

In some embodiments, the method further includes debinding the metallic fuel material of the body. For example, once a part is formed, the binder and particle oxide layer are removed. In some embodiments, debinding includes the use of solvent, catalytic, and/or thermal driven processes. In some embodiments, the part is then subjected to elevated temperature to achieve the desired final density (i.e. sintering step). For example, the elevated temperature may densify the material, promote recrystallization, promote interstitial growth, etc. In some embodiments, the elevated temperature may sinter at least a portion of the metallic fuel material. During the sintering step, the oxide layer produced during the passivation step may be removed under a controlled reducing atmosphere. In some embodiments, the de-passivation occurs under a reducing atmosphere consisting of 0.01-100% hydrogen content and/or the use of partial pressure (i.e., partial vacuum) ranging from 0.0001-760 torr.

The method further includes cladding the body with a cladding material that directly contacts the surface of the body without an intermediate bond layer therebetween. As described herein, a bond layer as used in a convention NFP is not necessary for a dimensionally stable body including porous metallic fuel material such as described herein. In some embodiments, the cladding is in direct contact with the metallic fuel material of the body. In some embodiments, the cladding is in direct contact with a second body material of the body.

In some embodiments, the cladding material is located around the body including the porous metallic fuel material in a radial direction relative to a longitudinal axis. In some embodiments, the cladding material is located at an axial surface(s) of the body in the longitudinal direction. In some embodiments, the cladding material is substantially continuous from the radially outward surface of the body to and/or across the axial surfaces of the body.

In some embodiments, the cladding material is located around the body including the porous metallic fuel material in a radial direction relative to a longitudinal axis. In some embodiments, the cladding material is located at an axial surface(s) of the body in the longitudinal direction with an axial layer between the body and the cladding material. In some embodiments, the cladding material is substantially continuous from the radially outward surface of the body to and/or across the axial layer(s). In some embodiments, the axial layer is or includes a bond layer, such as a helium bond layer and/or a sodium bond layer. In some embodiments, the axial layer(s) is or includes a nuclear fuel material, neutron capturing material, breeding material, inert material, etc. to control the burnup of the nuclear fuel material proximate to the axial surface of the body.

While embodiments of NFPs and metallic fuel materials having a porous structure have been described herein, in some embodiments, the metallic fuel material has a closed pore system, and, in some embodiments, the metallic fuel material has an open pore system. In some embodiments, the closed pore system includes a plurality of pores in the structure of the metallic fuel material between particles or grains. In some embodiments, the grains are microstructural grains exhibiting a single, continuous crystal structure in the grain. In some embodiments, the grains are individual particles, such as in the powder precursor mixed prior to the formation of the body of the NFP during manufacturing. For example, the particles of the metallic fuel material may sinter together to form the bonded grains of the closed pore system. In some embodiments, the pores of a closed pore system do not connect with one another to provide fluid flow therebetween. In some embodiments, a closed pore system has at least 50% of the pores isolated without fluid flow therebetween. In some embodiments, the closed pore system has at least 75% of the pores isolated without fluid flow therebetween.

In some embodiments, the grains of the metallic fuel material may be approximated as substantially spherical. In such examples, a close packing of the grains allows an open path of fluid flow between the particles, flowing fluid through the pores of the metallic matrix. In a particular example, hexagonal close packing of substantially spherical grains allows approximately 26% porosity in the resulting structure between the grains. In other examples, different aspect ratios and/or grain size distributions can allow control of the porosity of the metallic fuel material and/or gradients of porosity within the metallic fuel material.

The fluid flow into and/or through the pores of the metallic fuel material may allow a porous NFP to resist swelling during fissile reactions in a reactor. By limiting and/or preventing swelling, some embodiments of NFPs according to the present disclosure can have a larger volume of the fuel material in the body, be manufactured and/or disposed of more easily, and limit and/or prevent failures of the NFP during reaction.

The present disclosure relates to NFPs and systems and methods for manufacturing thereof according to at least the examples provided in the sections below:
Clause 1. A nuclear fuel pellet comprising: a metallic fuel material including a nuclear fuel, the metallic fuel material having a metallic matrix defining a porosity of at least 10% prior to a fissile reaction; and a cladding material positioned radially outward of the metallic fuel material relative to a longitudinal axis of the metallic fuel material.
Clause 2. The nuclear fuel pellet of clause 1, wherein the metallic fuel material directly contacts the cladding material without an intermediate layer therebetween.
Clause 3. The nuclear fuel pellet of clause 1, wherein the metallic fuel material has a porosity of no less than 25% prior to a fissile reaction.
Clause 4. The nuclear fuel pellet of clause 1, wherein at least a portion of the porosity of the metallic matrix includes a binder.
Clause 5. The nuclear fuel pellet of clause 4, wherein the binder includes a polymer.
Clause 6. The nuclear fuel pellet of clause 5, wherein the polymer includes one or more of polyethylene, polystyrene, or polypropylene.
Clause 7. The nuclear fuel pellet of clause 4, wherein the binder includes a plasticizer.
Clause 8. The nuclear fuel pellet of clause 7, wherein the plasticizer includes one or more of paraffin wax or palm oil.
Clause 9. The nuclear fuel pellet of clause 1, wherein the nuclear fuel pellet is cylindrical.
Clause 10. The nuclear fuel pellet of clause 1, wherein the nuclear fuel is passivated.
Clause 11. The nuclear fuel pellet of clause 1, wherein the nuclear fuel has an oxide layer thereon in the metallic matrix.
Clause 12. The nuclear fuel pellet of clause 1, wherein the metallic matrix includes a closed pore system.
Clause 13. The nuclear fuel pellet of clause 1, wherein the metallic matrix includes an open pore system.
Clause 14. A method of manufacturing a fuel pellet: forming a metallic fuel material including a nuclear fuel into a body with a metallic matrix having a porosity of no less than 10% prior to a fissile reaction; and cladding the body with a cladding material that directly contacts a radially outward surface of the body without an intermediate layer therebetween.
Clause 15. The method of manufacturing a fuel pellet of clause 14, wherein forming the metallic fuel material includes extruding the metallic fuel material.
Clause 16. The method of manufacturing a fuel pellet of clause 14, wherein forming the metallic fuel material includes additively manufacturing the metallic fuel material.
Clause 17. The method of manufacturing a fuel pellet of clause 14, wherein forming the metallic fuel material includes sintering the metallic fuel material.
Clause 18. The method of manufacturing a fuel pellet of clause 14, wherein forming the metallic fuel material includes debinding the body of the nuclear fuel pellet.
Clause 19. The method of manufacturing a fuel pellet of clause 14, wherein forming the metallic fuel material includes passivating the nuclear fuel prior to forming the metallic fuel material into the body.
Clause 20. A nuclear fuel pellet comprising: a cylindrical body, the body including a metallic fuel material including a nuclear fuel, wherein the metallic fuel material has a metallic matrix with an open porous system defining a porosity of at least 10% prior to a fissile reaction; and a cladding material contacting a radially outward surface and an axial surface of the metallic fuel material relative to a longitudinal axis of the metallic fuel material.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the scope of the present disclosure, and that various changes, substitutions, and alterations may be made to embodiments disclosed herein without departing from the scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

It should be understood that any directions or reference frames in the preceding description are merely relative directions or movements. For example, any references to “front” and “back” or “top” and “bottom” or “left” and “right” are merely descriptive of the relative position or movement of the related elements.

The present disclosure may be embodied in other specific forms without departing from its characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A nuclear fuel pellet comprising:
a metallic fuel material including a nuclear fuel, the metallic fuel material having a metallic matrix defining a porosity of at least 10% prior to a fissile reaction; and
a cladding material positioned radially outward of the metallic fuel material relative to a longitudinal axis of the metallic fuel material.

2. The nuclear fuel pellet of claim 1, wherein the metallic fuel material directly contacts the cladding material without an intermediate layer therebetween.

3. The nuclear fuel pellet of claim 1, wherein the metallic fuel material has a porosity of no less than 25% prior to a fissile reaction.

4. The nuclear fuel pellet of claim 1, wherein at least a portion of the porosity of the metallic matrix includes a binder.

5. The nuclear fuel pellet of claim 4, wherein the binder includes a polymer.

6. The nuclear fuel pellet of claim 5, wherein the polymer includes one or more of polyethylene, polystyrene, or polypropylene.

7. The nuclear fuel pellet of claim 4, wherein the binder includes a plasticizer.

8. The nuclear fuel pellet of claim 7, wherein the plasticizer includes one or more of paraffin wax or palm oil.

9. The nuclear fuel pellet of claim 1, wherein the nuclear fuel pellet is cylindrical.

10. The nuclear fuel pellet of claim 1, wherein the nuclear fuel is passivated.

11. The nuclear fuel pellet of claim 1, wherein the nuclear fuel has an oxide layer thereon in the metallic matrix.

12. The nuclear fuel pellet of claim 1, wherein the metallic matrix includes a closed pore system.

13. The nuclear fuel pellet of claim 1, wherein the metallic matrix includes an open pore system.

14. A method of manufacturing a fuel pellet:
forming a metallic fuel material including a nuclear fuel into a body with a metallic matrix having a porosity of no less than 10% prior to a fissile reaction; and
cladding the body with a cladding material that directly contacts a radially outward surface of the body without an intermediate layer therebetween.

15. The method of manufacturing a fuel pellet of claim 14, wherein forming the metallic fuel material includes extruding the metallic fuel material.

16. The method of manufacturing a fuel pellet of claim 14, wherein forming the metallic fuel material includes additively manufacturing the metallic fuel material.

17. The method of manufacturing a fuel pellet of claim 14, wherein forming the metallic fuel material includes sintering the metallic fuel material.

18. The method of manufacturing a fuel pellet of claim 14, wherein forming the metallic fuel material includes debinding the body of the nuclear fuel pellet.

19. The method of manufacturing a fuel pellet of claim 14, wherein forming the metallic fuel material includes passivating the nuclear fuel prior to forming the metallic fuel material into the body.

20. A nuclear fuel pellet comprising:
a cylindrical body, the body including a metallic fuel material including a nuclear fuel, wherein the metallic fuel material has a metallic matrix with an open porous system defining a porosity of at least 10% prior to a fissile reaction; and
a cladding material contacting a radially outward surface and an axial surface of the metallic fuel material relative to a longitudinal axis of the metallic fuel material.
